(19) United States
(12) Patent Application Publication
(10) Pub. No.: US 2005/0282471 A1
(43) Pub. Date: Dec. 22, 2005

(54) Chemical mechanical polishing slurry useful for tunsten/titanium substrate

(75) Inventors: Jong-Dai Park, Hwaseong-Si (KR); Dong-Wan Kim, Hwaseong-Si (KR)

Correspondence Address: BIRCH STEWART KOLASCH & BIRCH, PO BOX 747, FALLS CHURCH, VA, 22040-0747, US

(73) Assignee: DONGJIN SEMICHEM CO., LTD., Incheon (KR)

(21) Appl. No.: 11/153,624

(22) Filed: Jun. 16, 2005

(30) Foreign Application Priority Data
Jun. 18, 2004 (KR) 10-2004-0045639

(51) Int. Cl. B24D 3/02; C08H 1/00; B24B 1/00

(52) U.S. Cl. 451/41; 51/308; 106/3

(57) ABSTRACT

Disclosed is a chemical mechanical polishing (CMP) slurry having a superior polishing efficiency as well as being capable of effectively converting a metal layer to be polished into a metal oxide layer. The CMP slurry composition includes an abrasive, an oxidizing agent, an iron-doped colloidal silica, and water. Preferably, the amount of the iron-doped colloidal silica is 0.0001 to 0.5 weight % with respect to the total CMP slurry composition, and the iron-doped colloidal silica is produced by reacting a silica salt with an iron salt in an aqueous solution state. The preferable amount of Si contained in the silica salt is 2 to 10 times of the amount of Fe contained in the iron salt by mole ratio.

### FIELD OF THE INVENTION

This invention relates to a chemical mechanical polishing (CMP) slurry composition, and more specifically, to a CMP slurry composition containing iron-doped colloidal silica having a superior polishing efficiency as well as being capable of effectively converting a metal layer to be polished into a metal oxide layer.

### BACKGROUNDS OF THE INVENTION

An integrated semiconductor chip includes a large number of electrical elements, such as transistors, capacitors, resistors and so on, and the electrical elements are connected with conductive metal layers of a certain pattern to form functional circuits. The size of the integrated semiconductor chip becomes smaller and the functionality thereof becomes being magnified over several generations. To increase the integration degree of the semiconductor chip, the size of the electrical elements may be reduced. However, there is an inherent limitation in reducing the size of the electrical elements. Thus, a multilevel interconnection technology of the electrical elements has been actively studied and developed. In manufacturing a semiconductor device with the multilevel interconnection technology, a planarization process of a metal layer is indispensable. The metal layer cannot be easily polished due to its relatively high strength, and therefore, the metal layer should be converted into a metal oxide layer having a relatively low strength for effective polishing of the metal layer.

CMP slurry compositions for such polishing of a metal layer were disclosed in Korean Unexamined Publication Nos. 2004-29239, 2004-35073, 2004-35074 and 2004-55042. However, the CMP slurry compositions disclosed in the above-mentioned references have a disadvantage of not providing sufficient chemical conversion of the metal layer into the metal oxide layer. From 1876, Fenton's reagent, which is a composition composed with hydrogen peroxide and iron salt, is conventionally used for oxidizing a metal layer. However, in the method, an excess amount of iron salt is necessary, and the iron salt may badly influence the metal layer to be polished. Accordingly, it is necessary to develop an oxidizing agent which effectively oxidizes the metal layer and does not produce defects on the polished metal layer, effective abrasive particles, and an effective concentration of each component for producing effective CMP slurry composition.

### SUMMARY OF THE INVENTION

Therefore, it is an object of the present invention to provide a chemical mechanical polishing (CMP) slurry composition for effectively oxidizing a metal layer to be polished. It is other object of the present invention to provide a CMP slurry composition for reducing defects on the polished metal layer, which caused by a metal salt such as an iron salt in the CMP slurry composition.

To achieve these and other objects, the present invention provides a CMP slurry composition comprising an abrasive, an oxidizing agent, an iron-doped colloidal silica, and water. Preferably, the amount of the iron-doped colloidal silica is 0.0001 to 0.5 weight % with respect to the total CMP slurry composition, and the iron-doped colloidal silica is produced by reacting a silica salt with an iron salt in an aqueous solution state. The preferable amount of Si contained in the silica salt is 2 to 10 times of the amount of Fe contained in the iron salt by mole ratio. The present invention also provides a method for polishing a substrate including at least one metal layer comprising the steps of: preparing a chemical mechanical polishing slurry composition by admixing an abrasive, an oxidizing agent, an iron-doped colloidal silica, and water; applying the chemical mechanical polishing slurry composition to the substrate; and removing at least a portion of the metal layer from the substrate by contacting a pad with the substrate and moving the pad on the substrate. The present invention further provides a multiple package system for preparing chemical mechanical polishing slurry composition, wherein at least one component selected from an abrasive, an oxidizing agent, an iron-doped colloidal silica, and water is contained in one package, and the remaining at least one component selected from the abrasive, the oxidizing agent, the iron-doped colloidal silica, and water is contained in the other package.

### DETAILED DESCRIPTION OF THE INVENTION

A more complete appreciation of the invention, and many of the attendant advantages thereof, will be better appreciated by reference to the following detailed description.

The CMP slurry composition according to the present invention includes an iron-doped colloidal silica which works as an abrasive and an oxidizing agent at the same time, in addition to the conventional CMP slurry components, such as an abrasive, an oxidizing agent, and so on. Generally, the abrasive and the oxidizing agent are mixed with other components of the CMP slurry composition just before the polishing process, and used for the polishing process. Exemplary abrasive suitable for the present invention includes α-alumina, γ-alumina, fumed silica, colloidal silica, ceria (cerium oxide) and the mixture thereof. It is preferable to use the fumed silica as the abrasive in the present invention. The fumed silica has good stability with respect to the oxidizing agent such as hydrogen peroxide and good dispersion stability. In addition, the fumed silica can reduce the occurrence of scratches on the surface of the substrate to be polished. The amount of the abrasive is preferably 0.1 to 20.0 weight % with respect to the total of the CMP slurry composition, and more preferably the amount of the abrasive is 0.1 to 10.0 weight %. If the amount of the abrasive is less than 0.1 weight %, it is difficult to mechanically polish the surface of the substrate to be polished, and if the amount of the abrasive is more than 20.0 weight %, the dispersion stability thereof can be lowered.

The iron-doped colloidal silica (Fe/Si) contained in the CMP slurry composition of the present invention can be prepared by doping iron salt in the colloidal silica. For example, the iron-doped colloidal silica (Fe/Si) according to the present invention can be prepared by reacting a silica salt, such as SiCl₄, with an iron salt, such as FeCl₃, in an aqueous solution. The amount of Si contained in the silica salt is preferably 2 to 10 times of the amount of Fe contained in the iron salt by mole ratio. If the amount of Si is less than 2 times of that of Fe by mole ratio, the produced colloidal silica cannot accommodate all Fe, and excess amount of Fe is used for the polishing process. While if amount of Si is more than 10 times of that of Fe by mole ratio, the amount of Fe for the polishing process is too little, and therefore the sufficient abrasion and oxidization of the metal layer cannot be performed. The size of the iron-doped colloidal silica can be varied according to the process conditions, and is preferably 50 to 150 nm and more preferably 50 to 100 nm. If the size of the iron-doped colloidal silica is less than above-mentioned range, the polishing efficiency can be lowered, and if the size of the iron-doped colloidal silica is more than above-mentioned range, scratches can be formed on the surface of the substrate to be polished. The hydration reaction of the silica salt can be carried out at 5° C. or less, and preferably carried out at 1° C. or less. Also, it is preferable to dialyze ions, such as Cl⁻, contained in the hydration reaction solution so as to prevent the rapid growth of the final colloidal particles. The iron-doped colloidal silica works as the first oxidizing agent for oxidizing the metal layer, and also works as the abrasive. The amount of the iron-doped colloidal silica is preferably 0.0001 to 0.5 weight % with respect to the total CMP slurry composition, and more preferably 0.0001 to 0.3 weight %. If the amount of the iron-doped colloidal silica is less than 0.0001 weight %, it is difficult to obtain a synergic effect of the polishing and oxidation of the iron-doped colloidal silica, and if the amount of the iron-doped colloidal silica is more than 0.5 weight %, the oxidation force thereof is so big that a polishing defect such as a erosion of the metal layer can be occurred.

The oxidizing agent contained in the CMP slurry composition according to the present invention has a function to oxidize the metal layer for easy polishing of the metal layer, namely, works as the second oxidizing agent. Conventional oxidizing agent can be widely used as the oxidizing agent of the present invention. Exemplary oxidizing agent includes hydrogen peroxide, peroxydicarbonate, octanoyl peroxide, acetylbenzoyl peroxide and the mixtures thereof. Preferably, hydrogen peroxide can be used as the oxidizing agent. The amount of the oxidizing agent is preferably 0.1 to 5.0 weight % with respect to the total CMP slurry composition, and more preferably 0.2 to 4.0 weight %. If the amount of the oxidizing agent is less than 0.1 weight %, an oxide layer may not be effectively formed. If the amount of the oxidizing agent is more than 5.0 weight %, the polishing efficiency can be increased, but the excess oxidation power may induce the polishing defects such as erosion of the metal layer.

The CMP slurry composition of the present invention may further include an oxidizing assistant and a dispersion stabilizer. As the oxidizing assistant, 0.01 to 2.0 weight % of malonic acid with respect to the total chemical mechanical polishing slurry composition can be used. The oxidizing assistant can be used to delay the oxidation of the metal layer to prolong the oxidation reaction. If the amount of the oxidizing assistant is less than 0.01 weight %, the oxidation reaction time cannot be prolonged, and the lifetime of the CMP slurry composition can be short. If the amount of the oxidizing assistant is more than 2.0 weight %, a dispersion stability of the CMP slurry composition can be deteriorated. As the dispersion stabilizer, naphthalenesulfonic acid polymer can be used, and the preferable dispersion stabilizer is formaldehyde-naphthalenesulfonic acid polymer sodium salt. The amount of the dispersion stabilizer is preferably 0.0005 to 0.1 weight % with respect to the total CMP slurry composition. If the amount of the dispersion stabilizer is less than 0.0005 weight %, the dispersion stability of the CMP slurry composition is deteriorated, and if the amount of the dispersion stabilizer is more than 0.1 weight %, the dispersion stability is not further enhanced, but can be deteriorated in some case

The remaining component of the CMP slurry composition of the present invention is water, and preferably deionized water. Also, the CMP slurry composition of the present invention may further include a pH adjusting agent for controlling the pH of the slurry composition, an additional dispersion agent for preventing the gelation and a particle precipitation, a buffer solution for reducing the effect induced from the pH change of the CMP slurry composition, and various salts for reducing the viscosity of the CMP slurry composition. Exemplary pH adjusting agent includes nitric acid, acetic acid, phosphoric acid, hydrochloric acid and so on.

The CMP slurry composition of the present invention includes no or a very little ionized iron salts in the CMP slurry composition. Therefore, the defects possibly generated during the polishing process of the metal layer can be minimized, and process stability and manufacturing yield of the CMP process are excellent. The CMP slurry composition of the present invention firstly oxidizes the metal layer with the iron-doped colloidal silica, and then secondly oxidizes the metal layer with the conventional oxidizing agent, such as hydrogen peroxide, which results in the increase of the oxidation efficiency. In addition, the iron-doped colloidal silica also participates in mechanical polishing of the metal layer, which also results in the increase of the polishing efficiency.

The CMP slurry composition of the present invention can be supplied as one package system, in which all components of the CMP slurry composition are packaged in one container, or alternatively can be supplied as two or more package system, namely, multiple package system. In the multiple package system for preparing the CMP slurry composition, at least one component selected from the abrasive, the oxidizing agent, the iron-doped colloidal silica, and water is contained in one package, and the remaining at least one component selected from the abrasive, the oxidizing agent, the iron-doped colloidal silica, and water is contained in the other package. For example, if the two package system is used for the present invention, the first package may comprise the iron-doped colloidal silica (the first oxidizing agent) and optionally one or more conventional additives, and the second package may comprise the conventional oxidizing agent (the second oxidizing agent), an abrasive and/or water. In the other embodiment, the first package may comprise the abrasive, the iron-doped colloidal silica, the water, which are admixed to prepare a chemical mechanical polishing slurry composition precursor, and the second package may comprise the oxidizing agent. In another embodiment, the iron-doped colloidal silica is packaged in the first container, the abrasive is packaged in the second container, and other optional components of the CMP slurry composition are packed in the third container. Furthermore, the components in the first container or the second container may be in dry form, while the components in the third container are in the form of an aqueous dispersion.

The CMP slurry composition of the present invention can be used for polishing a substrate including at least one metal layer. For example, the substrate may include one or more tungsten containing metal layer, titanium containing metal layer, and titanium nitride containing metal layer. The method for polishing the substrate comprises the steps of: preparing a chemical mechanical polishing slurry composition by admixing an abrasive, an oxidizing agent, an iron-doped colloidal silica, and water; applying the chemical mechanical polishing slurry composition to the substrate; and removing at least a portion of the metal layer from the substrate by contacting a pad with the substrate and moving the pad on the substrate. The chemical mechanical polishing slurry composition can be produced by admixing an abrasive, an iron-doped colloidal silica, and water to prepare a chemical mechanical polishing slurry composition precursor; and admixing the chemical mechanical polishing slurry composition precursor with an oxidizing agent.

Hereinafter, preferable examples are provided for better understanding of the present invention. However, the present invention is not limited to the following examples.

### MANUFACTURING EXAMPLE

### Preparation of Iron-Doped Colloidal Silica

Deionized water was cooled to 1° C., and FeCl₃ was added into the deionized water with active stirring so that the concentration of FeCl₃ became 20 mol %. To the solution, SiCl₄, which was kept at −20° C. or less, was slowly and dropwisely added and stirred to prepare a colloidal solution. The amount of SiCl₄ was controlled so that the amount of Si in the SiCl₄ is 4 times of the amount of Fe in the FeCl₃ by the mole ratio. Cl⁻ ion contained in the colloidal solution was dialyzed with Spectra/Por membrane (MWCO: 6000-8000) at room temperature in order to prevent the rapid growth of particles in the final colloidal solution and to stabilize the particles, which results in the decrease of the ionic strength of the solution. The obtained solution was used for preparation of the CMP slurry composition.

### EXAMPLES 1-4 AND COMPARATIVE EXAMPLE 1

### Polishing Rate Test of CMP Slurry Composition According to Amount of Iron-Doped Colloidal Silica (Fe/Si)

A comparative CMP slurry composition including 5.0 weight % of fumed silica, 2.0 weight % of hydrogen peroxide, 0.01 weight % of FeCl₃/Fe₂(SO₄)₃, 0.06 weight % of malonic acid, 0.001 weight % of formaldehyde-naphthalenesulfonic acid polymer sodium salt and water as the remainder was prepared (Comparative example 1). In addition, CMP slurry compositions including 5.0 weight % of fumed silica, 2.0 weight % of hydrogen peroxide, iron-doped colloidal silica (Fe/Si) produced in the Manufacturing Example and of the amount shown in Table 1, 0.06 weight % of malonic acid, 0.001 weight % of formaldehyde-naphthalenesulfonic acid polymer sodium salt as a dispersion stabilizer and water as the remainder were prepared (Examples 1-4). The pH of the CMP slurry compositions were controlled with nitric acid or ammonia as shown in Table 1. The blanket wafer having tungsten metal layer and the blanket wafer having silicon oxide layer were separately polished with the CMP slurry compositions, and the removal rate thereof were measured and are set forth in Table 1. The polishing were carried out with a polishing equipment “POLI-500CE” manufactured by G&P technology Inc., STT™ W711 pad and NF-200 carrier film manufactured by Thomas West Inc. The polishing conditions were as follows: 50 rpm of platen speed, 50 rpm of head speed, 5 psi of down pressure, 150 ml/min of slurry supplying rate and 1 minute of polishing time.

TABLE 1

| | Amount | | Removal Rate | Removal Rate | |
|---|---|---|---|---|---|
| | of | | of tungsten | of silicon | |
| | Fe/Si | | metal layer | oxide layer | Selec- |
| | (ppm) | pH | (Å/min) | (Å/min) | tivity |
| Comparative | 0 | 2.35 | 2100 | 22 | 95 |
| example 1 | | | | | |
| Example 1 | 10 | 2.28 | 1710 | 21 | 81 |
| Example 2 | 50 | 2.3 | 1850 | 23 | 80 |
| Example 3 | 600 | 2.29 | 1920 | 22 | 87 |
| Example 4 | 3000 | 2.3 | 2080 | 21 | 99 |

As shown in Table 1, as the amount of the iron-doped colloidal silica (Fe/Si) increases, the removal rate of the tungsten metal layer and the selectivity increase. Also, the CMP slurry composition of the present invention has a removal rate of the tungsten metal layer and selectivity similar to the CMP slurry composition including ionized iron.

### EXPERIMENTAL EXAMPLE 1

### Polishing Quality Test When Patterned Metal Layer is Polished

A wafer, on which 0.18 μm pattern is formed, was over-polished for 20 seconds by using the CMP slurry compositions prepared in Comparative example 1 and Examples 1-4. The erosion, the oxide loss, the key hole formation and the plug recess of the polished metal pattern were measured, and are set forth in Table 2.

TABLE 2

| | Erosion | Oxide loss | Key hole | Plug recess |
|---|---|---|---|---|
| Comparative | 350 | 610 | Good | 300 |
| example 1 | | | | |
| Example 1 | 340 | 500 | Good | 250 |
| Example 2 | 310 | 580 | Good | 240 |
| Example 3 | 330 | 560 | Good | 255 |
| Example 4 | 300 | 600 | Good | 290 |

As shown in Table 2, the CMP slurry composition of the present invention is effective in preventing the erosion and the polishing defects such as the oxide loss, the key hole formation and the plug recess, which results from the fact that the CMP slurry composition of the present invention includes less iron ion compared with the conventional CMP slurry composition.

### EXPERIMENTAL EXAMPLE 2

### Stability Test of CMP Slurry Composition

In order to evaluate the stability of the CMP slurry compositions prepared in Comparative example 1 and Examples 1-4, the CMP slurry compositions were kept for 90-days. Then, the precipitation, the average particle size and the zeta potential of the slurry compositions were measured and set forth in Table 3.

TABLE 3

| | Precipitation | Zeta | Average | Average particle |
|---|---|---|---|---|
| | (after 90 | potential | particle size | size (after 90 |
| | days) | (mV) | (initial, nm) | days, nm) |
| Comparative | Yes | −12 | 172 | Not applicable |
| example 1 | | | | (precipitation) |
| Example 1 | No | −25 | 165 | 191 |
| Example 2 | No | −20 | 175 | 197 |
| Example 3 | No | −22 | 168 | 195 |
| Example 4 | No | −21 | 170 | 200 |

As shown in Table 3, the CMP slurry compositions of the present invention (Examples 1-4) have advantages in that there was no precipitation, the increase of average particle size was small and the zeta potential is low. Therefore, the CMP slurry composition of the present invention was more stable compared with the conventional CMP slurry composition (Comparative example 1).

As described above, the CMP slurry composition according to the present invention is capable of effectively converting the metal layer to be polished into the metal oxide layer, and is capable of reducing the polishing defects. In addition, the CMP slurry composition has superior dispersion stability. While the present invention has been described in detail with reference to the preferred embodiments, those skilled in the art will appreciate that various modifications and substitutions can be made thereto without departing from the spirit and scope of the present invention as set forth in the appended claims.

1. A chemical mechanical polishing slurry composition comprising:
an abrasive;
an oxidizing agent;
an iron-doped colloidal silica; and
water.

2. The chemical mechanical polishing slurry composition of claim 1, wherein the amount of the iron-doped colloidal silica is 0.0001 to 0.5 weight % with respect to the total chemical mechanical polishing slurry composition.

3. The chemical mechanical polishing slurry composition of claim 1, wherein the iron-doped colloidal silica is produced by reacting a silica salt with an iron salt in an aqueous solution state.

4. The chemical mechanical polishing slurry composition of claim 3, wherein the amount of Si contained in the silica salt is 2 to 10 times of the amount of Fe contained in the iron salt by mole ratio.

5. The chemical mechanical polishing slurry composition of claim 1, wherein the size of the iron-doped colloidal silica is 50 to 150 nm.

6. The chemical mechanical polishing slurry composition of claim 1, wherein the amount of the abrasive is 0.1 to 20.0 weight % with respect to the total chemical mechanical polishing slurry composition, and the amount of the oxidizing agent is 0.1 to 5.0 weight % with respect to the total chemical mechanical polishing slurry composition.

7. The chemical mechanical polishing slurry composition of claim 1, further comprising 0.01 to 2.0 weight % of malonic acid with respect to the total chemical mechanical polishing slurry composition and 0.0005 to 0.1 weight % of naphthalenesulfonic acid polymer with respect to the total chemical mechanical polishing slurry composition.

8. A method for polishing a substrate including at least one metal layer comprising the steps of:
preparing a chemical mechanical polishing slurry composition by admixing an abrasive, an oxidizing agent, an iron-doped colloidal silica, and water;
applying the chemical mechanical polishing slurry composition to the substrate; and
removing at least a portion of the metal layer from the substrate by contacting a pad with the substrate and moving the pad on the substrate.

9. The method for polishing a substrate of claim 8, wherein the chemical mechanical polishing slurry composition is produced by admixing the abrasive, the iron-doped colloidal silica, the water to prepare a chemical mechanical polishing slurry composition precursor; and admixing the chemical mechanical polishing slurry composition precursor with the oxidizing agent.

10. The method for polishing a substrate of claim 8, wherein the metal layer is selected from the group consisting of a tungsten containing metal layer, titanium containing metal layer, and titanium nitride containing metal layer.

11. A multiple package system for chemical mechanical polishing slurry composition, wherein at least one component selected from an abrasive, an oxidizing agent, an iron-doped colloidal silica, and water is contained in one package, and the remaining at least one component selected from the abrasive, the oxidizing agent, the iron-doped colloidal silica, and water is contained in the other package.
